(19) United States
(12) Patent Application Publication
(10) Pub. No.: US 2021/0216891 A1
(43) Pub. Date: Jul. 15, 2021

(54) METHODS AND SYSTEMS FOR PREDICTING USER-SPECIFIC DURABILITY OF A SHAVING DEVICE

(71) Applicant: Bic Violex S.A., Anixi (GR)

(72) Inventors: Konstantinos IOANNIDIS, Athens (GR); Vasileios STASINOS, Athens (GR); Georgios GEORGAKIS, Athens (GR)

(73) Assignee: Bic Violex S.A., Anixi (GR)

(21) Appl. No.: 17/107,536

(22) Filed: Nov. 30, 2020

Related U.S. Application Data
(60) Provisional application No. 62/959,002, filed on Jan. 9, 2020.

(51) Int. Cl. G06N 5/04; G06N 20/20; G06N 5/00; G06Q 30/06; A45D 44/00; B26B 21/40

(52) U.S. Cl. CPC G06N 5/04; G06N 20/20; G06N 5/003; B26B 21/4056; A45D 44/00; B26B 21/4087; A45D 2044/007; G06Q 30/0601

(57) ABSTRACT

A computer-implemented method of analyzing shaving may include receiving contextual data associated with one or more users from one or more data sources; training a machine learning model using the received contextual data; receiving user data from a user; determining a durability cluster of the user based on the received user data and the trained machine learning model; and performing a shaving improvement action based on the determined durability cluster.

This application claims benefit from U.S. Patent Application 62/959,002 filed on 9 Jan. 2020, the entirety of which is incorporated herein by reference.

### FIELD

The present disclosure relates to methods and systems for predicting durability of a shaving device. More particularly, the present disclosure relates to methods and systems for predicting user-specific durability of a razor blade or cartridge by utilizing a machine learning technique.

### BACKGROUND

Consumers of shaving products may benefit from knowing a proper time to replace their razor blade or cartridge, in order to avoid skin irritation and/or poor shaving experience. Consumers frequently go through such negative experiences before deciding to replace the razor blade or cartridge and may need to monitor their usage manually to seek a replacement in advance (for example, by observing discoloration of the lubricating strip of a razor). Predicting an appropriate time for replacing the razor blade or cartridge might be challenging, as the durability of a razor blade or cartridge depends not only on the properties of the product itself but also on the characteristics of the user, which are unique for every person.

The background description provided herein is for the purpose of generally presenting the context of the disclosure. Unless otherwise indicated herein, the materials described in this section are not prior art to the claims in this application and are not admitted to being prior art, or suggestions of the prior art, by inclusion in this section.

### BRIEF DESCRIPTION OF THE DRAWINGS

Embodiments of the present disclosure will now be described, by way of example only, with reference to the accompanying drawings in which:

FIG. 1 is a diagram showing various types of contextual data that may be collected from one or more data sources to build a machine learning model, according to one aspect of the present disclosure.

FIG. 2 is a diagram illustrating how behavioral clusters of users are determined based on performance scores, according to one aspect of the present disclosure.

FIG. 3 is a flowchart illustrating a method of training a machine learning model, according to one aspect of the present disclosure.

FIG. 4 is an exemplary graphical user interface of a shaver monitoring application, according to one aspect of the present disclosure.

FIG. 5A is a flowchart illustrating a method of classifying a user in a durability cluster based on user data, according to one aspect of the present disclosure.

FIG. 5B is a flowchart illustrating a method of determining a durability cluster of a user based on user data and a trained machine learning model.

FIG. 6 is an exemplary graphical user interface of another shaver monitoring application, according to one aspect of the present disclosure.

FIG. 7 shows a plurality of threshold durations and user data considered by machine learning models associated with the respective threshold durations, according to one aspect of the present disclosure.

FIG. 8 is a flowchart illustrating a method of determining a probability that a user should retain a shaving device for a threshold duration, according to one aspect of the present disclosure.

FIG. 9 illustrates an implementation of a computer system that may execute techniques presented herein.

### SUMMARY

Aspects of the disclosure include:

A computer-implemented method of analyzing shaving, the method comprising: receiving contextual data associated with one or more users from one or more data sources; training a machine learning model using the received contextual data; receiving user data from a user; determining a durability cluster of the user based on the received user data and the trained machine learning model; and performing a shaving improvement action based on the determined durability cluster.

A computer-implemented method of analyzing shaving, the method comprising: receiving contextual data associated with one or more users from one or more data sources; training a plurality of machine learning models using the received contextual data, the plurality of machine learning models being associated with a plurality of threshold durations respectively; receiving user selection of a threshold duration from the plurality of threshold durations; receiving user data from the user; determining a probability that the user should retain the shaving device for the selected threshold duration, based on the user data and the trained machine learning model associated with the selected threshold duration; and performing a shaving improvement action based on the determined probability.

### DETAILED DESCRIPTION

The present disclosure relates to methods and systems for predicting durability of a shaving device, particularly for predicting user-specific durability of a razor blade or cartridge by utilizing a machine learning technique and making recommendations for keeping or replacing the razor to specific users based on the predictions.

In one embodiment, various characteristics associated with users of a shaving razor (i.e., a shaver) may be collected from one or more data sources. The collected user characteristics (herein referred to as “contextual data”) may be used to train a machine learning model. The trained machine learning model may be configured to classify users into appropriate durability clusters. The trained machine learning model may be stored and used by various computing devices to provide information pertaining to durability (e.g., usable life) of razor blades or cartridges. For example, upon receiving user data from a user, a computing device may use the trained machine learning model to determine the durability cluster of the user based on the user data. Based on the determined durability cluster, the computing device may provide a recommendation to the user regarding whether to keep or replace the razor blade or cartridge, and/or provide other useful information that improves the shaving experience.

While a razor blade/cartridge associated with a shaving razor is detailed herein, the disclosed techniques may be similarly applicable to other components of a shaving razor, or to other shaving products and devices. In other words, the exemplary embodiments herein may not be limited to application with razor blades/cartridges, but may also be implemented with other components, devices, machines, systems, or in any other similar context in which the contemplated embodiments may be applicable.

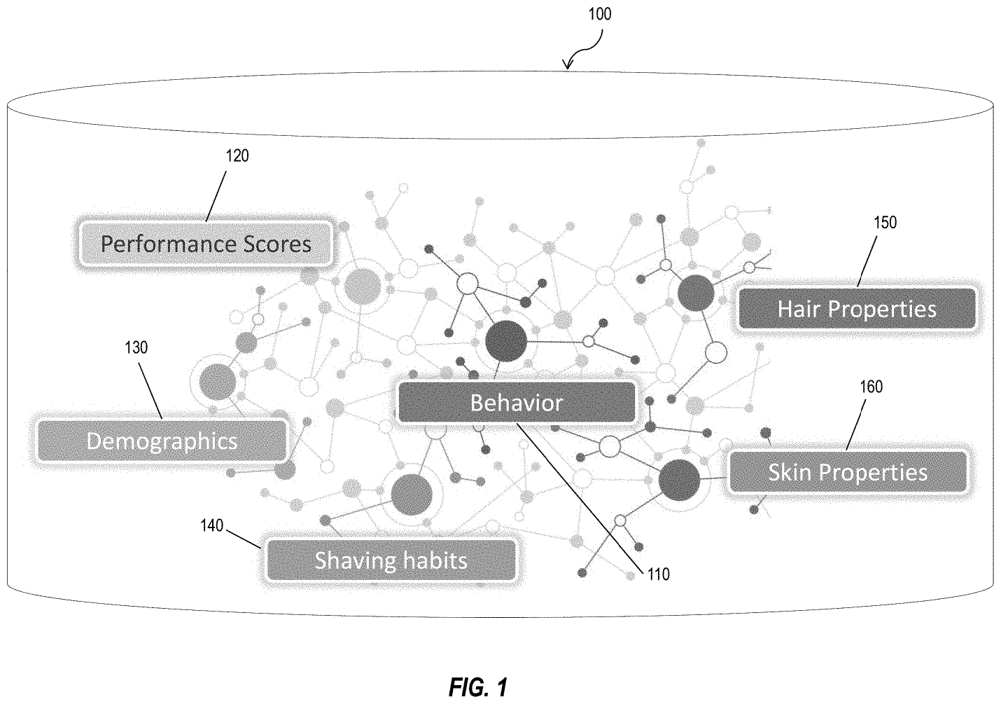

FIG. 1 is a diagram showing various types of contextual data that may be collected from one or more data sources to build a machine learning model. The data source(s) may comprise one or more databases or data storages storing contextual data. The contextual data may be collected by a shaver monitoring system 100. Shaver monitoring system 100 may be located remotely from the data source(s), or at least a portion of the data source(s) may be resident on or collocated with shaver monitoring system 100. The contextual data collected from the one or more data sources may include shaving behaviors 110, shaving performance scores 120, demographics 130, shaving habits 140, hair properties 150, and skin properties 160 pertaining to respective users, among other additional contextual data.

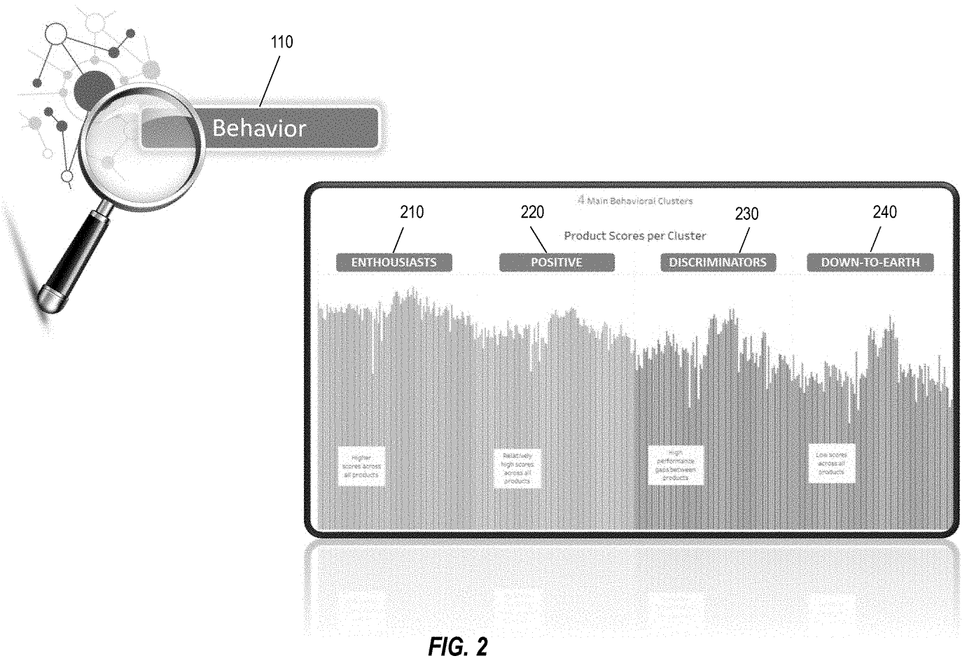

Specifically, shaving behavior 110 of a particular user may be determined based on shaving performance scores 120 given by the user for various shaving razors, each shaving razor including a razor blade or cartridge installed thereon. For example, a user may hold a shaving session and rate the overall performance of a shaving razor used during the session by providing a shaving performance score, and/or one or more other performance scores pertaining to particular aspects of the shaving performance. The shaving performance score may be associated with the user and/or the shaving razor (or the shaving blade/cartridge implemented thereon) and stored in a data source. A plurality of shaving performance scores 120 acquired in the aforementioned manner may then be collected by shaver monitoring system 110. As shown in FIG. 2, based on the shaving performance scores 120 given by the user, the user, or any future user, may be classified in one of multiple behavioral clusters. The behavioral clusters may include enthusiasts 210, positive 220, discriminators 230, and down-to-earth 240. Particularly, the user may be classified as an enthusiast 210 if the user gives high shaving performance scores 120 across various shaving razors and/or when rating any aspect of shaving or other performance, a positive 220 if the user gives relatively high shaving performance scores 120 across various shaving razors and/or when rating any aspect of shaving or other performance, a discriminator 230 if the shaving performance scores 120 given by the user vary or are inconsistent across various shaving razors and/or when rating any aspect of shaving or other performance, or a down-to-earth 240 if the user gives low shaving performance scores 120 across various shaving razors and/or when rating any aspect of shaving or other performance. Therefore, each of the users whose contextual data are collected by shaver monitoring system 100 may be classified in and associated with at least one of the behavioral clusters shown in FIG. 2.

With renewed reference to FIG. 1, demographics 130 may include age, gender, ethnicity, race, occupation, and/or other relevant characteristics of the users that might affect the durability or usable life of razor blades/cartridges. Shaving habits 140 may include information explaining how often a user holds a shaving session, a duration of each shaving session, whether a shaving session is supplemented with shaving products (e.g., shaving cream, etc.) other than a shaving razor, how often the razor is rinsed during a shaving session, a temperature of water used, a quantity of strokes for different regions in the body, a direction of the strokes, a time of day when the shaving session is held, a total area shaven per session, and/or other relevant shaving habits that might affect the durability or usable life of razor blades/cartridges. Hair properties 150 may include a hair thickness, a hair density, a condition of hair (e.g., dry, moist, etc.), a hair type (e.g., straight, wavy, curly, kinky, in-grown, etc.), a hair elasticity, a hair stiffness, and/or other relevant hair properties that might affect the durability or usable life of razor blades/cartridges. Skin properties 160 may include a condition of skin (e.g., dry, moist, sensitive, etc.), a skin elasticity, a skin hydration level, a skin barrier function indicator (e.g., trans-epidermal water loss (TEWL)), and/or other relevant skin properties that might affect the durability or usable life of razor cartridges.

It should be noted that the types of contextual data collected by shaver monitoring system 100 are not limited to the data types explicitly discussed in the current disclosure (i.e., shaving behaviors 110, shaving performance scores 120, demographics 130, shaving habits 140, hair properties 150, and skin properties 160), and may include any data that might be relevant to durability or usable life of razor blades/cartridges. It should be also noted that the contextual data may be captured by one or more sensors of shaving razors and transmitted to shaver monitoring system 100. Therefore, the one or more data sources of the contextual data may also include sensors of shaving razors, or the shaving razors themselves. Further, the contextual data may be data input into shaving applications installed on user computing devices and may be retrieved from storages associated with the shaving applications. Such storages may be resident on the user computing devices and/or remote servers in communication with the user computing devices.

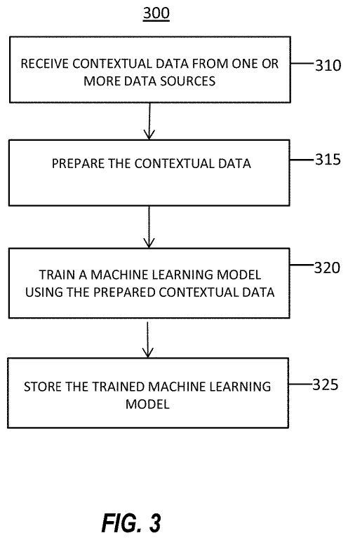

FIG. 3 is a flowchart illustrating a method of training a machine learning model, according to one aspect of the present disclosure. Notably, the steps of method 300 may be performed by shaver monitoring system 100 upon collecting various contextual data discussed above. The trained machine learning model may subsequently be used to analyze user data received from a user, and to determine a durability cluster appropriate for the user based on the analysis. Based on the determined durability cluster, shaver monitoring system 100 may predict a time at which the user is recommended to discard or replace the razor blade/cartridge and may alert the user (provide a recommendation) accordingly at the predicted time. In some embodiments, based on the determined durability cluster and, other factors, such as, e.g., the particular type of shaver selected, shaver monitoring system 100 may provide information pertinent to the user's shaving experience such as, for example, shaving tips, shaving suggestions to improve shaving habits, etc. Further, a machine learning model may be trained to detect a user's shaving pattern. For example, such trained machine learning model may be able to determine a probability that the user prefers a particular shaving razor or shaving product.

At step 310, shaver monitoring system 100 may receive contextual data (e.g., shaving behaviors 110, shaving performance scores 120, demographics 130 shaving habits 140, hair properties 150, and skin properties 160) from one or more data sources. The contextual data may be used to build or train a machine learning model contemplated in this disclosure.

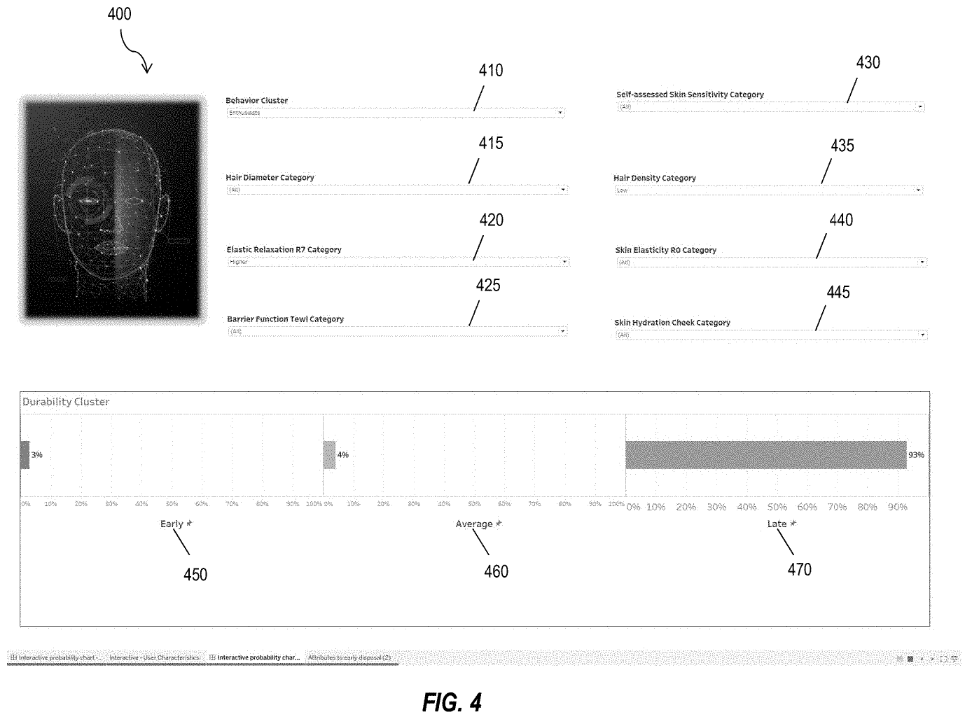

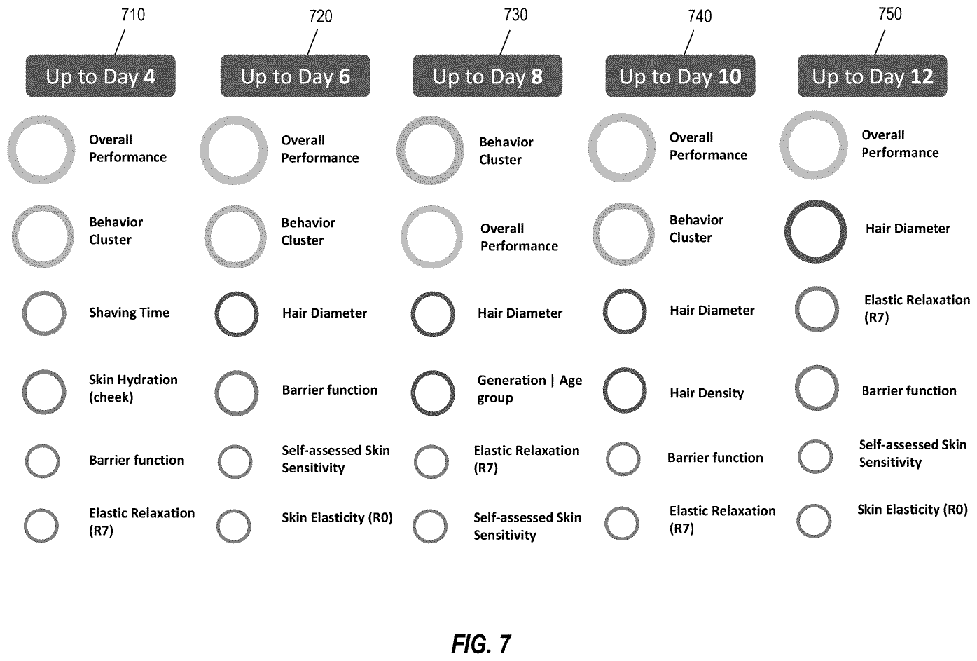

At step 315, shaver monitoring system 100 may prepare the received contextual data for model training. Data preparation may involve randomizing or sequencing the ordering of the contextual data, visualizing the contextual data to identify relevant relationships between different variables, identifying any data imbalances, splitting the contextual data into two parts where one part is for training a model and the other part is for validating the trained model, de-duplicating, normalizing, compressing (e.g., Discrete Cosine Transform (DCT), Discrete Fourier Transform (DFT), etc.), labeling instances (e.g., with appropriate durability clusters or threshold durations), correcting errors in the contextual data, and so on. In one embodiment, data preparation may involve associating each durability cluster (e.g., durability clusters 450, 460, 470 depicted in FIG. 4) with appropriate contextual data. In another embodiment, data preparation may involve associating each threshold duration (e.g., threshold durations 710, 720, 730, 740, 750 depicted in FIG. 7) with appropriate contextual data.

Once the contextual data is prepared, at step 320, shaver monitoring system 100 may train a machine learning model using the prepared contextual data. In one embodiment, the machine learning model may be trained in accordance with a random forest machine learning algorithm. Random forest, or random decision forest, is a supervised learning algorithm that is largely used for classification problems. Random forest is an ensemble learning method for classification, regression, and other tasks that operates by constructing a multitude of decision tress at the training stage, and outputting a class that is the mode of the classes (i.e., classification) or mean prediction (i.e., regression) of the individual trees. In other words, to classify a new object (i.e., a user characterized by user data) based on attributes (i.e., user data), each tree provides a classification (i.e., a durability cluster) associated with the new object, essentially “voting” for that classification. The forest then determines a final classification, which is the classification that has the most votes by all the trees in the forest. It should be noted that other machine learning algorithms may also be used to predict durability or usable life of shaving devices based on user data. For example, other applicable machine learning algorithms may include linear regression, logistic regression, support vector machine, Naïve Bayes, k-nearest neighbors, k-means clustering, dimensionality reduction algorithms, gradient boosting algorithms, etc.

With continuing reference to FIG. 3, at step 325, shaver monitoring system 100 may store the trained machine learning model in a system memory or storage. The trained machine learning model may then be used by user computing devices to predict durability or usable life of razor blades/cartridges.

FIG. 4 is an exemplary graphical user interface of a shaver monitoring application, according to one aspect of the present disclosure. Notably, shaver monitoring application 400 may classify the user in one of three or more durability clusters (e.g., early 450, average 460, and late 470) and provide probabilities of the user belonging to the respective durability clusters based on user data. In other words, the machine learning model utilized by shaver monitoring application 400 may be configured to, based on user data, classify the user in the most appropriate durability cluster based on probabilities determined for a plurality of durability clusters. Shaver monitoring application 400 may be part of shaver monitoring system 100 (e.g., an application running on shaver monitoring system 100), or may be implemented on a separate computing device in communication with shaver monitoring system 100 via a network.

It should be noted that the user inputting data via the graphical user interface of FIG. 4 may be a consumer of a shaving device inputting his or her own user characteristics, or may be an administrator/operator of shaver monitoring system 100 inputting user characteristics of a consumer being evaluated. Further, in some embodiments, the graphical user interface of FIG. 4 may be available only to an administrator/operator of shaver monitoring system 100, and a consumer may have access to a separate graphical user interface that translates and displays the results of shaver monitor application 400 in a more user-friendly manner. In other words, FIG. 4 might represent a graphical user interface of an administer/operator mode being provided by shaver monitoring application 400, while a more user-friendly consumer mode is also available via shaver monitoring application 400. Such a consumer mode may only request basic user characteristics and/or provide guidance on how to determine certain user characteristics (e.g., instructions on how to determine a skin type, hair thickness, user type, barrier function, etc.), and provide shaving device replacement recommendations and/or shaving tips or suggestions to the consumer based on the received user characteristics. Alternatively, FIG. 4 might simply depict a durability cluster determination algorithm/process being run in the back-end based on any user data received from a user or other data sources.

As shown in FIG. 4, a user may input various user characteristics that are relevant to his or her shaving experience and/or the durability of a razor blade/cartridge. The user data received by shaver monitoring application 400 may include behavioral cluster 410 (e.g., enthusiasts 210, positive 220, discriminators 230, and down-to-earth 240 explained above in reference to FIG. 2), hair diameter 415, elastic relaxation 420, barrier function (TEWL) 425, self-assessed skin sensitivity 430, hair density 435, skin elasticity 440, and skin hydration cheek 445. For each type of user data, the user may select an appropriate category by using a drop-down menu listing available categories. For example, the drop-down menu associated with the behavioral cluster 410 may list enthusiast, positive, discriminator, and down-to-earth categories the user can select from. The drop-down menu associated with the hair diameter 415 may list thin, medium, and thick categories, or may list diameter ranges representative of thin, medium, and thick hair types.

With continuing reference to FIG. 4, the barrier function (TEWL) 425 may list categories representative of various TEWL levels. TEWL, known as trans-epidermal water loss as explained above, indicates the loss of water that passes from inside a body through epidermis to the surrounding atmosphere via diffusion and/or evaporation processes, and is used as a skin barrier function indicator. The upper layer of the skin is called stratum corneum which consists of corneocytes and intercellular lamellar lipid bilayers, resembling a wall of bricks and cement. This wall functions as a barrier between the body and external factors such as, for example, irritant, allergens, and other environmental and biological factors, and ensures the integrity of the body and controls the exchange of substances with the environment. When the skin barrier is in a healthy condition, the cells are structured consistently, keeping water contents inside the skin and preventing external factors from entering. On the other hand, when the skin barrier is altered, the inner wall structure is disrupted. In this case, the water may not be retained effectively inside the skin and external factors may penetrate through the skin wall. The categories under the barrier function (TEWL) 425 may indicate varying levels of such water loss or vulnerability to external factors.

The categories under the self-assessed skin sensitivity 430 may include basic skin types such as, for example, normal, dry, oily, and combination skin. The categories under the hair density 435 may include thin, medium, and thick, or light, medium, and heavy. Alternatively, the categories under the hair density 435 may include measurement ranges representative of thin, medium, and thick hair density types. The skin elasticity 440 categories may include different levels of skin elasticity. The skin hydration cheek 445 categories may include different levels of hydration around a person's cheek region such as, for example, moist/oily, normal, and dry. It should be noted that the types of user data input to shaver monitoring application 400 are not limited to those explicitly discussed herein and may include other user characteristics that may impact durability of razor blades/cartridges. For instance, data that are similar or equivalent to the user characteristics collected by shaver monitoring system 100 for model training may be received by shaver monitoring application 400 as user data, and may be used to classify the user in a durability cluster and/or calculate probabilities for each of the durability clusters.

The user data received by shaving monitoring application 400 may then be analyzed using a trained machine learning model. In the case of a random forest machine learning model, each tree in the model may vote on which of the durability clusters (i.e., early 450, average 460, and late 470) the user should be classified in. For example, the “early” durability cluster 450 may indicate that the user should discard or replace the razor blade/cartridge between Day 1 and Day 8. The “average” durability cluster 460 may indicate that the user should discard or replace the razor blade/cartridge between Day 9 and Day 12. The “late” durability cluster 470 may indicate that the user should discard or replace the razor blade/cartridge between Day 13 and Day 16. However, the durability clusters may be associated with date ranges that are different from those explicitly discussed herein, and may be customized based on the type of the razor blade/cartridge and/or characteristics of the population from which contextual data are retrieved to train the machine learning model.

Based on the number of votes given to each durability cluster, shaver monitoring application 400 may determine the most appropriate durability cluster for the user (i.e., the durability cluster that receives the highest number of votes). Shaver monitoring application 400 may also calculate probabilities of the user belonging in the respective durability clusters, based on the number of votes received for each durability cluster. As explained above, it should be noted that other machine learning algorithms may also be used to determine the appropriate durability cluster and/or determine probabilities associated with the durability clusters.

In FIG. 4, shaver monitoring application 400 displays the probabilities calculated for the durability clusters. The probability for the “late” durability cluster 470 is the highest, suggesting that the user should discard or replace the razor blade/cartridge between Day 13 and Day 16. Based on the classification and/or probabilities calculated for each of the durability clusters, shaver monitoring application 400 may take further actions to improve the user's shaving experience. For example, shaver monitoring application 400 may transmit a notification to the user during the time period associated with the most probable durability cluster, the notification recommending the user to discard or replace the razor blade/cartridge. As another example, shaver monitoring application 400 may provide shaving tips and/or suggestions based on the determined classification and/or probabilities. The shaving tips and/or suggestions may be any tip or suggestion that might improve the user's shaving experience (e.g., skin care tips per day, suggestions to improve shaving habits and shaving strategy (e.g., shaving pattern, shaving with or against the grain, etc.), most appropriate shaver(s), skin care and/or cosmetic products to use based on skin and hair characteristics, recommended time and/or date to dispose the shaver cartridge, an estimated duration of the next shaving session, recommended time and/or date for the next shaving session, etc.) and/or prolong the usable life or durability of the razor blade/cartridge (e.g., a suggestion to reduce the number of shaving strokes to improve the lifespan of the shaver cartridge, etc.). Furthermore, before or during the time period associated with the most probable durability cluster, shaver monitoring application 400 may automatically connect to an electronic commerce (e-Commerce) server and place an order for a replacement blade/cartridge. To that end, shaver monitoring application 400 may operate in conjunction with a third-party or built-in electronic payment processing application.

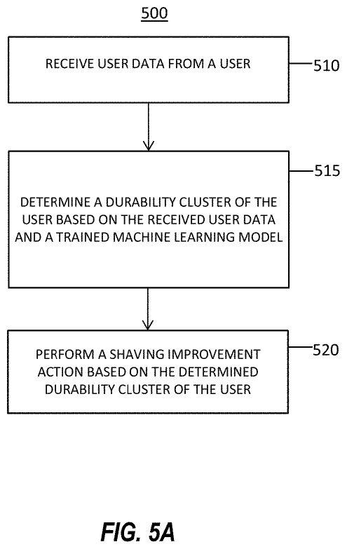

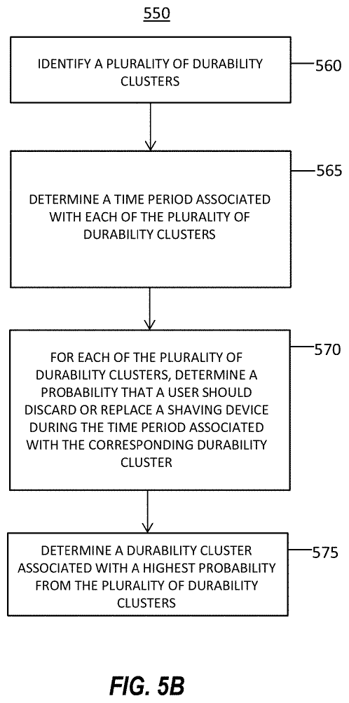

FIG. 5A is a flowchart illustrating a method of classifying a user in an appropriate durability cluster based on user data, according to one aspect of the present disclosure. Notably, the steps of method 500 may be performed by shaver monitoring application 400. At step 510, shaver monitoring application 400 may receive user data from a user. As explained above, the user data may include various user characteristics that are relevant to the user's shaving experience and may impact durability or usable life of the shaving device (e.g., razor blade/cartridge) currently being used. At step 515, shaver monitoring application 400 may determine a durability cluster of the user based on the received user data and a trained machine learning model. Step 515 is explained in greater detail below in reference to FIG. 5B.

FIG. 5B is a flowchart illustrating a method of determining a durability cluster of a user based on user data and a trained machine learning model. Method 550 may also be performed by shaver monitoring application 400. At step 560, shaver monitoring application 400 may identify a plurality of durability clusters. As explained above, the number of durability clusters and the time periods associated with the durability clusters may be configurable and may be predefined by an administrator or programmer of shaver monitoring application 400 and/or shaver monitoring system 100. At step 565, shaver monitoring application 400 may determine a time period associated with each of the plurality of durability clusters. At step 570, shaver monitoring application 400 may, for each of the plurality of durability clusters, determine a probability that the user should discard or replace the shaving device during the time period associated with the corresponding durability cluster. The probability determination at step 570 may be performed using the user data received at step 510 in FIG. 5A and a trained machine model explained above in reference to FIG. 3. At step 575, shaver monitoring application 400 may determine a durability cluster associated with a highest probability from the plurality of durability clusters. The durability cluster associated with the highest probability becomes the durability cluster of the user.

With renewed reference to FIG. 5A, at step 520, shaver monitoring application 400 may perform a shaving improvement action based on the determined durability cluster of the user. In one embodiment, the shaving improvement action may include presenting to the user the probabilities determined for the respective durability clusters, as shown in FIG. 4 for example. In another embodiment, shaver monitoring application 400 may present the durability cluster in which the user is classified (i.e., the durability cluster associated with the highest probability), with or without displaying the probabilities determined for all the durability clusters. In another embodiment, based on the classification and/or probabilities determined for the durability clusters, shaver monitoring application 400 may transmit a notification to the user during the time period associated with the most probable durability cluster, the notification alerting the user to discard or replace the shaving device. Alternatively, shaver monitoring application 400 may notify the user of the time period associated with the most probable durability cluster. In other embodiments, shaver monitoring application 400 may provide shaving tips and/or suggestions based on the determined classification and/or probabilities as discussed above. Furthermore, before or during the time period associated with the durability cluster of the user, shaver monitoring application 400 may automatically connect to an electronic commerce (e-Commerce) server and place an order for a replacement shaving device. To that end, shaver monitoring application 400 may operate in conjunction with a third-party or built-in electronic payment processing application.

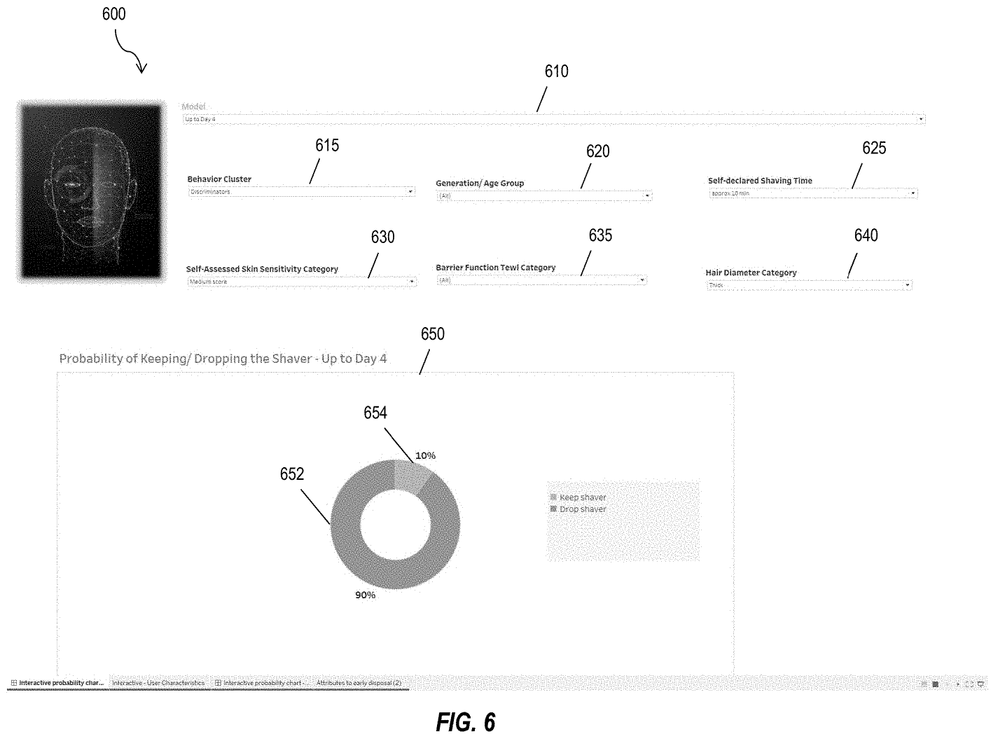

FIG. 6 is an exemplary graphical user interface of another shaver monitoring application, according to one aspect of the present disclosure. Notably, shaver monitoring application 600 may allow the user to select a machine learning model (e.g., a predictive model) from a plurality of machine learning models trained for varying threshold durations (e.g., up to Day 4, up to Day 6, up to Day 8, up to Day 10, up to Day 14). Using the selected machine learning model, shaver monitoring application 600 may determine a probability that the user may retain a shaving device for a threshold duration associated with the selected machine learning model. In other words, the selected machine learning model may be configured to determine the probability that the user may retain the shaving device for a threshold duration associated with the selected machine learning model.

It should be noted that the user inputting data via the graphical user interface of FIG. 6 may be a consumer of a shaving device inputting his or her own user characteristics, or may be an administrator/operator of shaver monitoring system 100 inputting user characteristics of a consumer being evaluated. Further, in some embodiments, the graphical user interface of FIG. 6 may be available only to an administrator/operator of shaver monitoring system 100, and a consumer may have access to a separate graphical user interface that translates and displays the results of shaver monitor application 600 in a more user-friendly manner. In other words, FIG. 6 might represent a graphical user interface of an administer/operator mode being provided by shaver monitoring application 600, while a more user-friendly consumer mode is also available via shaver monitoring application 600. Such a consumer mode may only request basic user characteristics and/or provide guidance on how to determine certain user characteristics (e.g., instructions on how to determine a skin type, hair thickness, barrier function, etc.), and provide shaving device replacement recommendations and/or shaving tips or suggestions to the consumer based on the received user characteristics. Alternatively, FIG. 6 might simply depict a probability determination algorithm/process being run in the back-end, based on any user data received from a user or other data sources.

As shown in FIG. 6, a user may select a machine learning model from a plurality of machine learning models trained for respective threshold durations. The machine learning models may be represented by the respective threshold durations when displayed via the graphical user interface. For example, the drop-down menu associated with the model 610 may list the threshold durations associated with the respective machine learning models. Therefore, from the user's point of view, a threshold duration may be selected from a plurality of threshold durations, which equates to selecting a machine learning model associated with the selected threshold duration.

In addition to model selection, the user may input various types of user characteristics that are relevant to the user's shaving experience and/or durability of the shaving device. The user data received by shaver monitoring application 600 may include behavioral cluster 615 (e.g., enthusiasts 210, positive 220, discriminators 230, and down-to-earth 240 explained above in reference to FIG. 2), generation/age group 620, self-declared shaving time 625, self-assessed skin sensitivity 630, barrier function (TEWL) category 635, and hair diameter 640. Similar to FIG. 4, for each type of user data, the user may select an appropriate category by using a drop-down menu listing available categories. Again, it should be noted that the types of user data input to shaver monitoring application 600 are not limited to those explicitly discussed herein and may include other user characteristics that may impact durability of razor blades/cartridges. For instance, data that are similar or equivalent to the user characteristics collected by shaver monitoring system 100 for model training may be received by shaver monitoring application 600 as user data and may be used to determine the probability associated with the selected threshold duration.

Once the user selects the threshold duration and inputs the user data, the machine learning model associated with the selected threshold duration may analyze the user data. In the case of a random forest machine learning model, based on the user data, each tree in the model may vote on whether or not the user should retain the razor blade/cartridge for the selected threshold duration. Based on the number of votes given to each scenario (i.e., where the user should retain the razor blade/cartridge and where the user should replace the razor blade/cartridge), shaver monitoring application 600 may determine the probability for each scenario. However, as explained above, it should be noted that other machine learning algorithm may also be used to determine probabilities associated with different threshold durations.

In FIG. 6, upon the user selecting the threshold duration “up to Day 4” and providing the user data, shaver monitoring application 600 presents the probability that the user should retain the razor blade/cartridge up to Day 4 as 10%, and the probability that the user should discard or replace the razor blade/cartridge by Day 4 as 90%. Given this data, the user will recognize that it may be beneficial to discard or replace the razor blade/cartridge within 4 days for a better shaving experience. As explained above with reference to FIG. 4, shaver monitoring application 600 may take additional actions to further improve the user's shaving experience. For example, shaver monitoring application 600 may transmit a notification to the user during a threshold duration, the notification recommending the user to either retain or discard the razor blade/cartridge. As another example, shaver monitoring application 600 may provide shaving tips and/or suggestions based on the probability determined for the selected threshold duration. Furthermore, based on the probability determined for the selected threshold duration, shaver monitoring application 600 may automatically connect to an electronic commerce (e-Commerce) server and place an order for a replacement blade/cartridge. To that end, shaver monitoring application 600 may operate in conjunction with a third-party or built-in electronic payment processing application.

FIG. 7 shows a plurality of threshold durations that may be selected by the user, and the user data considered by the machine learning models associated with the respective threshold durations. The threshold durations may include “up to Day 4” 710, “up to Day 5” 720, “up to Day 8” 730, “up to Day 10” 740, and “up to Day 12” 750. A threshold duration may specify a number of minutes, a number of hours, a number of days, a number of weeks, a number of months, a number of years, or a combination of one or more of the foregoing. In FIG. 7, different types of user data are listed under each threshold duration in the order of importance. For example, for the machine learning model associated with the threshold duration “up to Day 4” 710, the overall performance (e.g., performance scores) might have the highest weight while the elastic relaxation might have the lowest among the listed six types of user data. The user data types listed under each threshold duration in FIG. 7 may represent the user data types 615, 620, 625, 630, 635, 640 presented for user selection in FIG. 6. For each machine learning model associated with the respective threshold duration, the user data type associated with the highest weight will have the strongest impact in the probability determination.

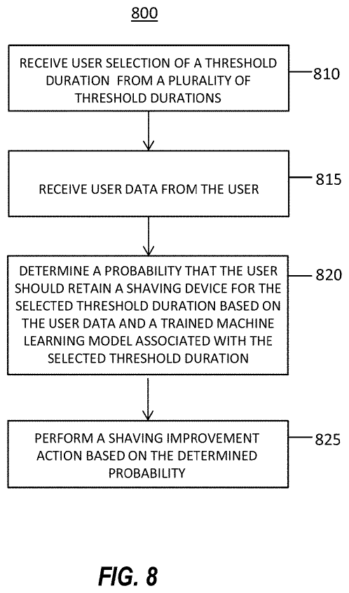

FIG. 8 is a flowchart illustrating a method of determining a probability that a user should retain a shaving device for a threshold duration, according to one aspect of the present disclosure. Notably, the steps of method 800 may be performed by shaver monitoring application 600. At step 810, shaver monitoring application 600 may receive user selection of a threshold duration. As explained above, each threshold duration may be associated with a corresponding machine learning model, the machine learning model being configured to determine the probability that the user should retain a shaving device for the threshold duration. Therefore, user selection of a threshold duration equates to a selection of a machine learning model associated with the selected threshold duration. At step 815, shaver monitoring application 600 may receive user data from the user. As discussed above, the user data may include various user characteristics that are relevant to the user's shaving experience and may impact durability or usable life of the shaving device currently being used. At step 820, shaver monitoring application 600 may determine a probability that the user should retain the shaving device for the selected threshold duration, based on the user data and the trained machine learning model associated with the selected threshold duration.

At step 825, shaver monitoring application 600 may perform a shaving improvement action based on the determined probability. In one embodiment, the shaving improvement action may include presenting to the user the probability determined for the selected threshold duration, as shown in FIG. 6 for example. In another embodiment, shaver monitoring application 600 may present a recommendation to either retain or discard/replace the shaving device, with or without displaying the probability determined for the selected threshold duration. In another embodiment, shaver monitoring application 600 may transmit a notification to the user during the threshold duration, the notification recommending the user to either retain or discard/replace the shaving device. In other embodiments, shaver monitoring application 600 may provide shaving tips and/or suggestions based on the probability determined for the selected threshold duration. Furthermore, based on the probability determined for the selected threshold duration, shaver monitoring application 600 may automatically connect to an electronic commerce (e-Commerce) server and place an order for a replacement shaving device. To that end, shaver monitoring application 600 may operate in conjunction with a third-party or built-in electronic payment processing application.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

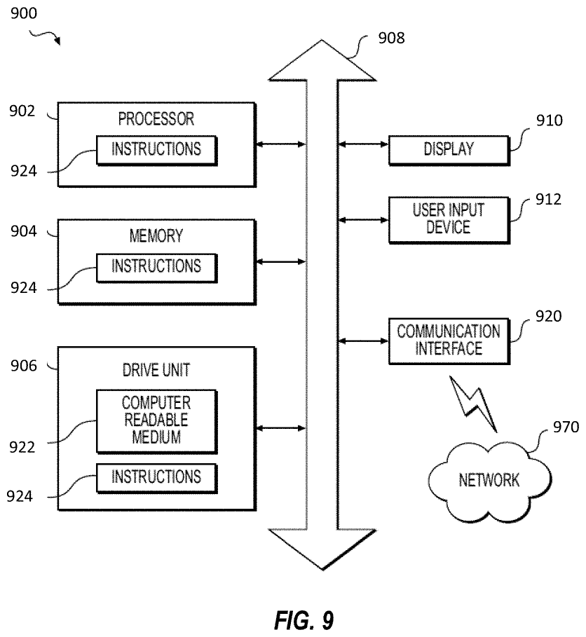

FIG. 9 illustrates an implementation of a computer system designated 900. The computer system 900 can include a set of instructions that can be executed to cause the computer system 900 to perform any one or more of the methods or computer-based functions disclosed herein. The computer system 900 may operate as a standalone device or may be connected, e.g., using a network, to other computer systems or peripheral devices.

In a networked deployment, the computer system 900 may operate in the capacity of a server or as a client user computer in a server-client user network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 900 can be implemented using electronic devices that provide voice, video, or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 904 includes a cache or random-access memory for the processor 902. In alternative implementations, the memory 904 is separate from the processor 902, such as a cache memory of a processor, the system memory, or other memory. The memory 904 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 904 is operable to store instructions executable by the processor 902. The functions, acts or tasks illustrated in the figures or described herein may be performed by the programmed processor 902 executing the instructions stored in the memory 904. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 900 may further include a display unit 910, such as a liquid crystal display (LCD), an organic light emitting diode (OLED), a flat panel display, a solid-state display, a cathode ray tube (CRT), a projector, a printer or other now known or later developed display device for outputting determined information. The display 910 may act as an interface for the user to see the functioning of the processor 902, or specifically as an interface with the software stored in the memory 904 or in the drive unit 906.

Additionally or alternatively, the computer system 900 may include an input device 912 configured to allow a user to interact with any of the components of system 900. The input device 912 may be a number pad, a keyboard, or a cursor control device, such as a mouse, or a joystick, touch screen display, remote control, or any other device operative to interact with the computer system 900.

The computer system 900 may also or alternatively include a disk or optical drive unit 906. The disk drive unit 906 may include a computer-readable medium 922 in which one or more sets of instructions 924, e.g. software, can be embedded. Further, the instructions 924 may embody one or more of the methods or logic as described herein. The instructions 924 may reside completely or partially within the memory 904 and/or within the processor 902 during execution by the computer system 900. The memory 904 and the processor 902 also may include computer-readable media as discussed above.

In some systems, a computer-readable medium 922 includes instructions 924 or receives and executes instructions 924 responsive to a propagated signal so that a device connected to a network 970 can communicate voice, video, audio, images, or any other data over the network 970. Further, the instructions 924 may be transmitted or received over the network 970 via a communication port or interface 920, and/or using a bus 908. The communication port or interface 920 may be a part of the processor 902 or may be a separate component. The communication port 920 may be created in software or may be a physical connection in hardware. The communication port 920 may be configured to connect with a network 970, external media, the display 910, or any other components in system 900, or combinations thereof. The connection with the network 970 may be a physical connection, such as a wired Ethernet connection or may be established wirelessly as discussed below. Likewise, the additional connections with other components of the system 900 may be physical connections or may be established wirelessly. The network 970 may alternatively be directly connected to the bus 908.

While the computer-readable medium 922 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 922 may be non-transitory and may be tangible.

The computer-readable medium 922 can include a solid-state memory such as a memory card or other package that houses one or more non-volatile read-only memories. The computer-readable medium 922 can be a random-access memory or other volatile re-writable memory. Additionally or alternatively, the computer-readable medium 922 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 900 may be connected to one or more networks 970. The network 970 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 970 may include wide area networks (WAN), such as the Internet, local area networks (LAN), campus area networks, metropolitan area networks, a direct connection such as through a Universal Serial Bus (USB) port, or any other networks that may allow for data communication. The network 970 may be configured to couple one computing device to another computing device to enable communication of data between the devices. The network 970 may generally be enabled to employ any form of machine-readable media for communicating information from one device to another. The network 970 may include communication methods by which information may travel between computing devices. The network 970 may be divided into sub-networks. The sub-networks may allow access to all of the other components connected thereto or the sub-networks may restrict access between the components. The network 970 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

While there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method of analyzing shaving, the method comprising:
receiving contextual data associated with one or more users from one or more data sources;
training a machine learning model using the received contextual data;
receiving user data from a user;
determining a durability cluster of the user based on the received user data and the trained machine learning model; and
performing a shaving improvement action based on the determined durability cluster.

2. The computer-implemented method of claim 1, wherein the contextual data comprises one or more of: shaving behaviors, shaving performance scores, demographics, shaving habits, hair properties, or skin properties.

3. The computer-implemented method of claim 1, wherein the machine learning model is a random forest model.

4. The computer-implemented method of claim 1, wherein the user data comprises one or more of: a user behavior, a hair diameter, a barrier function, a skin sensitivity, a hair density, a skin elasticity, or a cheek skin hydration.

5. The computer-implemented method of claim 1, wherein determining a durability cluster of the user comprises:
identifying a plurality of durability clusters;
determining a time period associated with each of the plurality of durability clusters;
for each of the plurality of durability clusters, determining a probability that the user should discard or replace the shaving device during the time period associated with the corresponding durability cluster; and
determining a durability cluster associated with a highest probability from the plurality of durability clusters.

6. The computer-implemented method of claim 1, wherein the durability cluster of the user is associated with a time period in which the user should discard or replace the shaving device.

7. The computer-implemented method of claim 6, wherein performing a shaving improvement action comprises:
before or during the time period associated with the durability cluster of the user, connecting to an electronic commerce server and placing an order for a replacement shaving device.

8. The computer-implemented method of claim 6, wherein performing a shaving improvement action comprises:
transmitting a notification to the user during the time period associated with the durability cluster of the user, the notification alerting the user to discard or replace the shaving device.

9. A computer-implemented method of analyzing shaving, the method comprising:
receiving contextual data associated with one or more users from one or more data sources;
training a plurality of machine learning models using the received contextual data, the plurality of machine learning models being associated with a plurality of threshold durations respectively;
receiving user selection of a threshold duration from the plurality of threshold durations;
receiving user data from the user;
determining a probability that the user should retain the shaving device for the selected threshold duration, based on the user data and the trained machine learning model associated with the selected threshold duration; and
performing a shaving improvement action based on the determined probability.

10. The computer-implemented method of claim 9, wherein the contextual data comprises one or more of: shaving behaviors, shaving performance scores, demographics, shaving habits, hair properties, or skin properties.

11. The computer-implemented method of claim 9, wherein the machine learning model is a random forest model.

12. The computer-implemented method of claim 9, wherein the user data comprises one or more of: a user behavior, a hair diameter, a barrier function, a skin sensitivity, a hair density, a skin elasticity, or a cheek skin hydration.

13. The computer-implemented method of claim 9, wherein each of the plurality of threshold durations comprises one or more of: a number of minutes, a number of hours, a number of days, a number of weeks, a number of months, or a number of years.

14. The computer-implemented method of claim 9, wherein the shaving device is a razor blade or a razor cartridge.

15. The computer-implemented method of claim 9, wherein performing a shaving improvement action comprises:
displaying the probability that the user should retain the shaving device for an entirety of the selected threshold duration.
